(19) United States
(12) Patent Application Publication
(10) Pub. No.: US 2013/0011532 A1
(43) Pub. Date: Jan. 10, 2013

(54) Convenient release mold

(76) Inventor: Andrea Rae Wolf, West Harrison, IN (US)

(21) Appl. No.: 13/135,483

(22) Filed: Jul. 7, 2011

(51) Int. Cl. A23G 9/04; A23G 9/22; B29C 35/08

(52) U.S. Cl. 426/241; 425/174.4

(57) ABSTRACT

An improved mold for frozen bars, especially frozen confections on a stick, that allow a quick and convenient release of the frozen confections from the molds by microwave radiation, said molds being made of plasticizer-free, unadulterated, nonrecycled, heat-stable, microwave-transmissible plastic; a method using said mold to produce said frozen confections including the step of using microwave radiation to quickly and conveniently release said confections from said mold; and an article of manufacture comprising the mold hereinabove, in association with instructions for use.

### BACKGROUND OF THE INVENTION

1. Field of the Invention

This invention relates to improved molds for forming and preparing frozen confections, especially frozen confections on a stick, such as flavored ice and ice cream, that allow a quick and convenient release of the frozen confections from the molds by microwave radiation, said molds being made of plasticizer-free, unadulterated, nonrecycled, heat-stable, microwave-transmissible plastic. This invention also relates to a method using said molds to produce said frozen confections including the step of using microwave radiation to quickly and conveniently release said confections from said molds.

2. Description of the Related Art

The first popsicle is disclosed in U.S. Pat. No. 1,505,592 issued Aug. 19, 1924 to F. W. Epperson, which discloses a method for making frozen confections on a stick using test tubes to contain liquid syrup and a wooden stick. When the freezing operation is completed the container is immersed in luke warm water to loosen the frozen confection from the container to remove the confection from the container. A negative of such mold is such glass test tubes can be accidentally and easily broken or shattered.

Subsequently, many apparatuses are designed for mass productions of frozen confections with sticks on a large, industrial scale. A frozen confection apparatus generally includes mold members having metallic mold cups or containers arranged in rows on a conveyor. Confection material is dispensed into the cups of each row by a filling station or filling unit, then the cups are exposed to a cooling medium for freezing, commonly by immersing in a cold brine tank for the heat to be transferred from the confections to the brine solution. At some point during the freezing process, sticks are inserted into the partially frozen confections. After the confections are completely frozen, heat is applied to the outer surfaces of the mold cups to thaw the outer layer of the frozen confection material in contact with the cups to allow the release and removal of the frozen confections from the molds. U.S. Pat. No. 3,031,978 issued May 1, 1962 and No. 3,261,178 issued Jul. 19, 1966 disclose such frozen confection machines, wherein the molding cups are made of metal, such as stainless steel and wherein the molds containing frozen confections with wooden sticks are immersed into a hot water tank to release the frozen confections from their molds.

U.S. Pat. No. 3,695,895 issued Oct. 3, 1972 discloses another apparatus with metal molds, but the hot water tanks are replaced by spray nozzles that dispense streams of heated water to release the frozen confections from their molds.

U.S. Pat. No. 3,403,639 issued Oct. 1, 1968 discloses a similar apparatus to produce blocks of frozen food products such as ice cream, edible soups, cooked meat in gravy, vegetable, corn, etc. wherein such products do not have inserted sticks. This apparatus also uses molds formed of non-corroding materials such as nickel or stainless steel and the frozen food blocks are released by thawing tanks containing heated liquid.

U.S. Pat. No. 4,104,411 issued Aug. 1, 1978 discloses thin-walled molds made of flexible, elastic material (rubber, latex), such molds allow the production of frozen confections of re-entrant shape, where thickness and width of the molded unit can increase and decrease along the length of the product. Once the frozen confections are solidified, each mold turns progressively inside out, that is, progressively introvert, during withdrawal of the handle to unpeel the mold from the frozen confection. In some cases, the molds are anchored elastically so as to prevent complete introversion and therefore simplify subsequent operations such as cleaning and re-filling. These molds are necessarily so elastic and flexible that they are readily deformed and require that the filled molds be held above the liquid level of the refrigerant tank until the product shape has set by the exterior of the liquid within the mold becoming frozen. Rubber and latex can contain plasticizer to improve resilience and elasticity. Latex can cause allergic reactions.

There are also disclosures of mold assemblies for preparing frozen confections at home. U.S. Pat. No. 2,946,207 issued Jul. 26, 1960 discloses a mold assembly consisting of a plurality of individual cups integrally joined together with a web or sheet. Each cup has a lid or cap with a stick-like arm depending therefrom that is immersed in the liquid contained in the cup to support the resulting frozen article when the liquid is frozen in a freezer compartment of a home refrigerator. Each cap also has a handle situated on the opposite side of the stick-like arm. The integral cups and web are made of resilient plastic material such as polyethylene, polypropylene, polystyrene, and polyvinyl chloride. No instructions are provided for how the frozen confections are to be released from the cups. The risk of the presence of plasticizer in the resilient plastic material is not appreciated.

U.S. Pat. No. 4,239,175 issued Dec. 16, 1980 discloses an improvement over U.S. Pat. No. 2,946,207, wherein each lid or cap that serves to retain any molten liquid is provided with a straw member to allow the molten liquid therein to be drawn off. The mold assembly is formed from a synthetic plastic material. No instructions are provided for how the frozen confections are to be released from the cups except a disclosure that the cap member can be lifted upwardly to remove the frozen product from the cup member.

U.S. Pat. No. 5,354,191 issued Oct. 11, 1994 discloses a variation from U.S. Pat. No. 4,239,175, with the mold assembly comprising a planar tray member wherein the cups can either be integral parts of the tray member or be removably mounted in the openings of the tray member, and wherein the caps (or covers) of the cups also include passageway arrangement to draw off any melted liquid. The mold assembly can be made from any suitable synthetic plastic materials. For consumption, the cover and holder assemblies can each be removed with the frozen food product from its associated container by any of a plurality of heating techniques, such as applying hot water to the outer surface of the container. The risk of the presence of plasticizer in the resilient plastic material is not appreciated.

In the hereinabove U.S. Pat. Nos. 2,946,207, 4,239,175, and 5,354,191, there is no anticipation of heating by microwave radiation nor indication of concern of a potential of leaching or migrating of toxic plasticizers from the plastic to the comestible confection, especially upon heating, especially heating under microwave radiation, nor a potential of degradation of plastic that can result upon heating, especially heating under microwave radiation, to form toxic by-product ingredients that would contaminate the comestible confection.

U.S. Pat. No. 3,411,463 issued Nov. 19, 1968 discloses a mold assembly comprising a rigid plastic tray having openings to hold a series of metallic cups, each cup is covered by a flexible stick-supporting cap having a slot that is centrally located to frictionally hold a wooden stick. The flexibility of the plastic cap allows it to be snapped to the rim of the cup. The cups are filled with confection liquid then inserted in the openings of the tray, and the whole assembly is placed in the freezer compartment of a home refrigerator to be frozen. It is disclosed that the frozen comestible can be separated from its cup by subjecting the latter for a short period of time to the heat of a human hand. The metallic cups do not contain plasticizer but they are not microwave-transmissible to allow heating by microwave.

U.S. Pat. No. 6,301,919 issued Oct. 16, 2001 discloses a machine that can be used by children to make ice cream bars on a stick wherein the machine includes metal containers to receive and hold ice cream bar mix.

Homemade ice cream bars or popsicles are usually frozen in the freezer compartment of a home refrigerator, and the frozen bars are extracted from the molds by warming the outside of the molds to melt the interface of the frozen bars and molds then pulled from the molds using the inserted sticks. The common method for warming the molds is to place them upside down or sideways under a stream of hot or warm tap water. A commercially available mold assembly that comprises eight cups integrally joined together with a plate that is produced by Arrow Plastic Manufacturing Co., Elk Grove, Ill. 60007, has the following instructions: “Fill to just below top. Insert sticks and place in freezer. To remove, run water on outside of pops.” This heating method is not efficient because the water flow and coverage are not uniform, thus the hot water is not applied uniformly. Furthermore, the walls of the plastic molds are heat-insulating, so that it usually takes some time to thaw the surface of the frozen bars. Also, the water flow is not easily controlled, such that water spilling into the inside of the molds to contaminate the comestible bars can occur.

It is therefore an object of the present invention to provide an improved mold for forming and preparing frozen food blocks, preferably frozen confections that allow a quick and convenient release of the frozen food blocks and confections that also avoid the step of releasing the confections by hot running water that may contaminate the frozen confections.

Other objects and advantages will become apparent and understood by reference to the following detailed description of the preferred embodiments that follows.

### SUMMARY OF THE INVENTION

The present invention relates to improved molds for forming and preparing frozen food blocks, preferably frozen confections, preferably frozen confections on a stick, such as flavored ice and ice cream, that allow a quick release of the frozen confections by microwave radiation, said molds being made of microwave-safe, plasticizer-free, unadulterated, nonrecycled, heat-stable, microwave-transmissible plastic.

This invention also relates to a method of producing frozen food blocks, preferably frozen confection bars, including the steps of placing liquid confection material in molds made of plasticizer-free, unadulterated, nonrecycled, heat-stable, microwave-transmissible plastic; placing the molds in a freezing compartment to freeze the liquid, and using microwave radiation, such as from a microwave oven, to thaw the outer layer of the frozen food blocks or frozen confection bars to quickly and conveniently release said frozen confections from said molds.

This invention also relates to an article of manufacture that provides frozen confection molds that are made of microwave-safe, plasticizer-free, unadulterated, nonrecycled, heat-stable, microwave-transmissible plastic, and that optionally provides other parts such as wooden sticks, and instructions for use; and wherein such molds can carry an indicia that, e.g., identifies the molds, describes their convenient use, etc. It is important to provide instructions that indicate that the molds can safely be used in a microwave oven for quickly, conveniently, and hygienically releasing the confections from the molds, to provide the user with an appropriate incentive for using the invention.

In this document, the term “about” is presumed to modify all numerical values, it being understood that exact numerical values are not required unless it is specifically stated.

### DETAILED DESCRIPTION OF THE INVENTION

The present invention relates to a mold for forming and preparing frozen food blocks, preferably frozen confection bars that is an improvement over existing molds, said mold allows a quick release of the frozen confections from the mold by microwave radiation, wherein said mold is made using microwave-safe plastic comprising plasticizer-free, unadulterated, nonrecycled, heat-stable, microwave-transmissible plastic. “Microwave-safe plastic,” as used herein, means plasticizer-free, unadulterated, nonrecycled, heat-stable, microwave-transmissible plastic that does not release harmful ingredients to the confections upon heating with microwave radiation. “Plasticizer free,” as used herein, means that the plastic material used in the present invention does not contain plasticizers, which are additives to plastics to make them more flexible. Plasticizers can be harmful to the health, even carcinogenic, when consumed, even at low levels. Plasticizers are not bound to plastic and can migrate out of plastic, especially by heating, more especially by heating by microwave which is essential for the method of heating of the present invention, and contaminate the confection to be consumed. “Unadulterated,” as used herein, means that the plastic material used in the present invention is not blended with other types of plastics or recycled plastics. “Nonrecycled,” as used herein, means that the plastic used in the present invention does not contain any recycled plastic, which is plastic material that had been used before and is recycled and blended with new plastic.

Recycled plastic is mixtures of prior used plastics that are collected from many sources, some of which can contain plasticizers. “Heat-stable,” as used herein, means that the plastic used in the present invention is not degraded by heat. Polymers such as polystyrene and polycarbonate are generally not heat stable and also contain bisphenol A. Polyvinyl chloride plastic normally contains phthalate plasticizer and bisphenol A. “Microwave transmissible,” as used herein, means that the material allows a substantial amount of microwave radiation to pass through. Plastic materials normally are microwave-transmissible except when they are embedded with metallic materials. Metallic molds are generally not microwave-transmissible. Preferred plastic material for use in the present invention include plasticizer-free, unadulterated, and nonrecycled polyethylene terephthalate (polyester), plasticizer-free, unadulterated, and nonrecycled polypropylene, plasticizer-free, unadulterated, and nonrecycled high density polyethylene, plasticizer-free, unadulterated, and nonrecycled low density polyethylene, and semi-rigid silicone rubber. Due to its flexible nature even without containing plasticizer, semi-rigid silicone rubber is a preferred material to make the lid of the individual mold. For the purpose of this invention, molds made with glass, rubber, latex, or metal are not preferred. Polyvinyl chloride, polystyrene, and polycarbonate should be avoided.

The present invention relates to mold members for industrial apparatuses which are designed for productions of frozen food blocks, such as, those disclosed in U.S. Pat. No. 3,031,978 issued May 1, 1962 to M. B. Rasmusson, No. 3,261,178 issued Jul. 19, 1966 to K. Okada, and No. 3,403,639 issued Oct. 1, 1968 to K. Hirahara et al., said patents and the references cited therein are incorporated herein by reference, wherein said mold members are made of plasticizer-free, unadulterated, nonrecycled, heat-stable, microwave-transmissible plastic. These mold members allow a quick release of the frozen food blocks from the molds by microwave radiation, instead of the need of heating the mold using the traditional thawing tanks containing heated liquid.

The present invention preferably relates to mold members for industrial apparatuses which are designed for productions of frozen confections with sticks on a large scale, wherein said mold members are made of plasticizer-free, unadulterated, nonrecycled, heat-stable, microwave-transmissible plastic. These mold members allow a quick release of the frozen confections from the mold by microwave radiation, instead of the need of heating the mold using the traditional thawing tanks containing heated liquid, such as, those disclosed in U.S. Pat. No. 3,031,978 issued May 1, 1962 to M. B. Rasmusson and No. 3,261,178 issued Jul. 19, 1966 to K. Okada, or spray nozzles that dispense streams of heated water to release the frozen confections from their molds, as disclosed in U.S. Pat. No. 3,695,895 issued Oct. 3, 1972 to J. S. Brown.

At home, the consumer has endured for many years the problems of inconvenient removal of frozen confections by the use of running water. It is surprising that heating by microwave radiation still can preserve the integrity of the frozen confection bars, and this novel heating method for releasing frozen confection bars has provided more convenience and safety in the preparation of frozen confections for home consumption.

Thus the present invention also relates to a mold assembly consisting of a plurality of individual molds integrally joined together with a frame (or web, or sheet) as disclosed in U.S. Pat. No. 2,946,207 issued Jul. 26, 1960 to Hulterstrum, said patent is incorporated herein by reference, wherein each said individual mold comprises a container member (or cup) to contain a flavored liquid and a removable lid member (or cap) with a stick-like arm depending therefrom that is immersed in the liquid contained in the cup to support the resulting frozen article when the liquid is frozen in a freezer compartment of a home refrigerator; wherein each cap also has a handle situated on the opposite side of the stick-like arm; and wherein the integral cups and web are made of plasticizer-free, unadulterated, nonrecycled, heat-stable, microwave-transmissible plastic. Alternatively, said removable lid member is a stick-supporting lid having a slot that is centrally located in said lid to frictionally hold a wooden or plastic stick and divide said stick into a handle and an anchor. Preferably said lid is flexible and is made of semi-rigid silicone rubber and said stick is a wooden stick.

The present invention also relates to a mold assembly consisting of a frame (or tray) and a plurality of individually molds that can be removable from said frame, wherein said frame has a flat top and spaced feet for supporting same, said top having a series of similar openings, wherein said molds are removably mounted in said openings, wherein each of said mold comprises a container member (or cup) to contain a flavored liquid and a lid member (or cap) with a stick-like arm depending therefrom that is immersed in the liquid contained in the cup to support the resulting frozen article when the liquid is frozen in a freezer; wherein each lid also has a handle situated on the opposite side of the stick-like arm; as disclosed in U.S. Pat. No. 5,354,191 issued Oct. 11, 1994 to Bobis, said patent is incorporated herein by reference; and wherein the mold assembly is made of plasticizer-free, nonrecycled, heat-stable, microwave-transmissible plastic. Alternatively, each said cup is covered by a flexible stick-supporting lid member having a slot that is centrally located to frictionally hold a separate wooden or plastic stick, preferably wooden, as disclosed in U.S. Pat. No. 3,411,463 issued Nov. 19, 1968 to Moseres, which is incorporated herein by reference, wherein said cup and lid is made of plasticizer-free, unadulterated, nonrecycled, heat-stable, microwave-transmissible plastic. Preferably said lid is flexible and is made of semi-rigid silicone rubber.

Those skills in the art will recognize that other forms of these general types of molds can be used without departing from the scope of the present invention.

Homemade confection bars or popsicles are frozen in the freezer compartment of a home refrigerator, and the frozen bars are extracted from the molds by warming the outside of the molds to melt the interface of the frozen bars and molds then pulled from the molds using the inserted sticks. The common method for warming the molds is to place them upside down or sideways under a stream of hot or warm tap water. This heating method is not efficient because the water flow and coverage are not uniform, thus the hot water is not applied uniformly to the whole frozen bars, and from frozen bar to frozen bar in the mold assembly. Furthermore, the walls of the plastic molds are heat-insulating, so that it usually takes some time to thaw the surface of the frozen bars. Also, the water flow is not easily controlled, such that water spilling to the inside of the molds to contaminate the comestible bars can occur. It is found surprisingly that microwave radiation can be used to uniformly heating the surface of the frozen bars to easily and conveniently release the frozen bars from their molds, providing that this heating procedure does not release any toxic materials from the molds to the frozen confection bars. The need to exclude the toxic plasticizers from the molds, especially when the molds are to be used with microwave, is not appreciated in the frozen confection art.

The present invention thus relates to a method for making a frozen food block that allows a quick and easy release of said frozen food block including the steps of

(1) providing a mold made of plasticizer-free, unadulterated, nonrecycled, heat-stable, microwave-transmissible plastic;

(2) placing the food to be frozen into said mold;

(3) freezing said food; and

(4) heating the frozen food in the mold for thawing the outer layer of said frozen food using microwave radiation to quickly release said frozen food from the mold.

The present invention also relates to a method of producing frozen confections including the steps of: placing liquid confection material in molds or containers of the mold assembly that is made of plasticizer-free, unadulterated, nonrecycled, heat-stable, microwave-transmissible plastic; inserting and securing a flat plastic or wooden sticks, preferably with round ends, into the confection material with the wide faces of said stick preferably extending parallel to the wide dimensions of said molds, if said molds have various dimensions; placing the mold assembly in a freezing compartment to freeze the liquid; and using microwave radiation, such as a microwave oven, for thawing the outer layer of the frozen confection bar to quickly and conveniently release said frozen confections from said molds. The heating time needed to heat the mold assembly in the microwave oven to release and remove the frozen confections varies depending on the power of the microwave oven and on the number of frozen confections that are in the mold assembly. Normally the required heating time is in the range of at least about 10 seconds, at least about 20 seconds, at least about 30 seconds, and up to about 100 seconds, up to about 80 seconds, up to about 60 seconds. Depending on the power of the microwave oven, the heating time for each individual mold container is from about 3 seconds to about 20 seconds.

The present invention also relates to an article of manufacture that provides frozen confection molds that are made of microwave-safe, plasticizer-free, unadulterated, nonrecycled, heat-stable, microwave-transmissible plastic, and that optionally provides other parts such as plastic or wooden sticks, and instructions for use; and wherein such molds can carry an indicia that, e.g., either identifies the molds, describes their convenient use, etc. It is important to provide instructions that indicate that the molds can be safely used in a microwave oven for quickly, conveniently, and hygienically releasing the confections from the molds, to provide the user with an appropriate incentive for using the invention. The set of instructions can be printed, e.g., on one or more of the package, the accompanying instruction flyer, and/or communicated via print and/or electronic mass media, e.g., newspapers, magazines, radio, television, internet, circulars, and the like. The instructions can be in words, or illustrative images and/or icons including in combination with words.

The above description discloses some typical embodiments of the present invention. However, persons of ordinary skill in the art are capable of creating numerous modifications within the scope of the claims. Changes in specifics of form and details can be made to the above-described embodiments. The claims and not the examples are the measure of the protected invention.

What is claimed is:

1. A mold for making frozen food block, wherein the mold is made of plasticizer-free, unadulterated, nonrecycled, heat-stable, microwave-transmissible plastic, which allows a quick release of the frozen food blocks from the mold by microwave radiation.

2. The mold of claim 1 wherein the plasticizer-free, unadulterated, nonrecycled, microwave-transmissible plastic is selected from the group consisting of high density polyethylene, low density polyethylene, polypropylene, polyethylene terephthalate, and semi-rigid silicone rubber.

3. The mold of claim 1 wherein the frozen food block is a frozen confection on a stick.

4. The mold of claim 3, wherein said mold is a mold member of an industrial apparatus which is designed for production of frozen confections with sticks on a large scale.

5. A mold assembly comprising a plurality of individual molds of claim 3, wherein said molds are joined together with a frame, and wherein each said mold comprises a container member to contain a flavored liquid and a removable lid member that supports a stick that serves both as a handle and an anchor that is immersed in the liquid contained in the container to support the resulting frozen bar when the liquid is frozen in a freezer.

6. The mold assembly of claim 5 wherein said container members of said plurality of molds are integrally molded with said frame.

7. The mold assembly of claim 5 wherein said frame has a flat top and spaced feet for supporting same, said top having a series of similar openings, wherein said container members of said plurality of molds are removably mounted in said openings.

8. The mold assembly of claim 5 wherein said stick and said lid are made of a same plastic material, wherein said stick is integrally molded with said lid member, and wherein said stick comprises a stick-like arm depending from said lid member and a handle situated on the opposite side of the stick-like arm from the lid member.

9. The mold assembly of claim 5 wherein said removable lid member is a stick-supporting lid having central collar with a longitudinal slot that is centrally located in said lid to frictionally hold and support a separate wooden or plastic stick to divide said stick into a handle and an anchor.

10. The mold assembly of claim 9 wherein said lid is made of semi-rigid silicone rubber and said plastic stick is made of plasticizer-free, unadulterated, nonrecycled, heat-stable, microwave-transmissible plastic.

11. An article of manufacture comprising the mold assembly comprising a plurality of individual molds, wherein said molds are joined together with a frame, and wherein each said mold comprises a container member to contain a flavored liquid and a removable lid member that supports a stick that serves both as a handle and an anchor that is immersed in the liquid contained in the container to support the resulting frozen bar when the liquid is frozen in a freezer.

12. The article of claim 11 wherein said article provides instructions for use indicating that the molds can be safely used in a microwave oven for quickly, conveniently, and hygienically releasing the confections from the molds, and wherein said instructions for use are printed on one or more of the package; the accompanying instruction flyer; and/or communicated via print and/or electronic mass media: newspapers, magazines, radio, television, internet, circulars, and the like, and wherein said instructions can be in words, or illustrative images and/or icons including in combination with words.

13. The article of claim 11 wherein said wherein said container members of said plurality of molds are integrally molded with said frame.

14. The article of claim 11 wherein said frame has a flat top and spaced feet for supporting same, said top having a series of similar openings, wherein said container members of said plurality of molds are removably mounted in said openings.

15. A method for making a frozen food block that allows a quick and easy release of said frozen food block including the steps of:
(1) providing a mold made of plasticizer-free, unadulterated, nonrecycled, heat-stable, microwave-transmissible plastic;
(2) placing the food to be frozen into said mold;
(3) freezing said food; and
(4) heating the frozen food in the mold for thawing the outer layer of said frozen food using microwave radiation to quickly release said frozen food from the mold.

16. The method of claim 15 wherein the food to be frozen is a flavored liquid syrup and said frozen food is a frozen confection.

17. The method of claim 16 wherein said mold is a mold assembly comprising a plurality of individual molds joining together with a frame, and wherein each said individual mold comprises a container member and a removable lid member, wherein said removable lid member comprises either an interior stick-like anchor and an exterior handle which are integrally molded to said lid; or a central collar with a longitudinal slot that is centrally located in said lid to frictionally hold and support a separate wooden or plastic stick and to divide said stick into a handle and an anchor, and wherein said container member, said lid member, and said separate plastic stick are made of plasticizer-free, unadulterated, nonrecycled, heat-stable, microwave-transmissible plastic.

18. The method of claim 17 wherein the heating time is from about 10 seconds to about 100 seconds.

19. The method of claim 18 wherein the heating time is from about 20 seconds to about 60 seconds.

20. The method of claim 17 wherein said lid comprising said collar with slot is made of semi-rigid silicone rubber.
